(19) United States
(12) Patent Application Publication
(10) Pub. No.: US 2026/0341183 A1
(43) Pub. Date: Oct. 29, 2026

(54) Optical Signal Element for Medical Device

(71) Applicant: Becton, Dickinson and Company, Franklin Lakes, NJ (US)

(72) Inventors: Ashley Rachel Rothenberg, Morris Plains, NJ (US); Dylan Gregory DeBoer, Vernon Hills, IL (US); Erik Kurt Witt, Oakland, NJ (US)

(21) Appl. No.: 19/114,479

(22) PCT Filed: Sep. 25, 2023
(86) PCT No.: PCT/US23/33602

§ 371 Date: Mar. 24, 2025

Related U.S. Application Data
(60) Provisional application No. 63/409,929, filed on Sep. 26, 2022.

(51) Int. Cl. G09F 3/00; G09F 3/02

(52) U.S. Cl. CPC G09F 3/0291; G09F 3/0297; G09F 2003/0257; G09F 2003/0266; G09F 2003/0272

(57) ABSTRACT

A system may include a medical device and an optical signal element associated with the medical device, such that when the optical signal element is in a first state, the optical signal element provides a first indication regarding the medical device, and when the optical signal element is in a second state, the optical signal element provides a second indication regarding the medical device, the second indication being different from the first indication.

### CROSS-REFERENCE TO RELATED APPLICATION

The present application claims priority to U.S. Provisional Application Ser. No. 63/409,929 entitled “Optical Signal Element for Medical Device” filed Sep. 26, 2022, the entire disclosure of which is hereby incorporated by reference in its entirety.

### BACKGROUND

A single-use medical device may include a medical instrument or a medical apparatus that is intended to be used once in a medical setting, such as a hospital or a clinic, and then be disposed. For example, a single-use medical device may include a device entitled by the manufacturer for one single patient and one procedure only. A single-use medical device may not be reusable and may, therefore, have a short lifespan and is limited to one patient. A reusable medical device may include a medical instrument or a medical apparatus that is intended to require reprocessing after a procedure, such as cleaning, disinfecting, and/or sterilization.

However, labelling of a medical device may not provide accurate information with regard to whether the medical device is a single-use medical device or a reusable medical device. Further, a medical device may lack an indication with regard to whether the medical device has been used before or if the medical device has been reprocessed after a procedure. For instance, a user, such as a doctor, may visually inspect a label on the packaging of a medical device at the time that the packaging is removed from the medical device. In such an instance, the doctor may use the medical device right away after removing the packaging. For example, the doctor may not administer a medication from the medical device at the time that the packaging is removed. Where another user attempts to use the medical device, the other user may not be aware of the status of the medical device with regard to use. Therefore, a label that does not show an indication of use or reuse of a medical device may not be accurate with regard to whether the medical device was used. Further, the medical device may go unused after the packaging is removed and may be wasted if the status of the medical device with regard to use is not clear.

### SUMMARY

Accordingly, provided are improved systems, devices, products, apparatus, and/or methods for determining a characteristic of a medical device based on an optical signal element.

In accordance with an embodiment of the present invention, a system includes an optical signal element associated with a medical device. When the optical signal element is in a first state, the optical signal element provides a first indication regarding the medical device, and when the optical signal element is in a second state, the optical signal element provides a second indication regarding the medical device, wherein the second indication is different from the first indication.

In accordance with an embodiment of the present invention, the system further includes at least one processor programmed or configured to receive data associated with the optical signal element, determine a characteristic of the medical device based on the data associated with the optical signal element, and perform an action based on the characteristic of the medical device.

In accordance with an embodiment of the present invention, the optical signal element includes a window having a material; and a cover; and wherein, when the optical signal element is in the first state, the window is held in an open position by the cover; and wherein, when the optical signal element is in the second state, the material of the window covers an opening of the window so that the window is in a closed position; and wherein the optical signal element transitions from the first state to the second state based on the cover being removed and the material of the window relaxing over the opening of the window.

In accordance with an embodiment of the present invention, the optical signal element may be configured to transition from the first state to the second state based on a mechanical operation carried out on the optical signal element.

In accordance with an embodiment of the present invention, the optical signal element transitions from the first state to the second state based on mechanical deformation of the optical signal element.

In accordance with an embodiment of the present invention, when performing the action based on the characteristic of the medical device, the at least one processor is programmed or configured to provide an alert, wherein the alert comprises information indicating that the medical device was improperly connected to another component.

In accordance with an embodiment of the present invention, when performing the action based on the characteristic of the medical device, the at least one processor is programmed or configured to provide a prompt. The prompt may include information indicating that a connection of the medical device to another component should be corrected to properly connect the medical device.

In accordance with an embodiment of the present invention, when performing the action based on the characteristic of the medical device, the at least one processor is programmed or configured to provide a message, wherein the message comprises information indicating that the medical device was properly connected to another component.

In accordance with an embodiment of the present invention, when receiving the data associated with the optical signal element attached to the medical device, the at least one processor is programmed or configured to receive the data associated with the optical signal element attached to the medical device from an optical reader device.

In accordance with an embodiment of the present invention, the optical signal element may be configured to transition from the first state to the second state based on a physical property of a component of the optical signal element.

In accordance with an embodiment of the present invention, the optical signal element may be configured to transition from the first state to the second state based on a change in matter of a component of the optical signal element.

In accordance with an embodiment of the present invention, the optical signal element associated with the medical device may be attached to a connector associated with the medical device, and wherein the connector is configured to establish a connection with the medical device.

In accordance with an embodiment of the present invention, a transition of the optical signal element from the first state to the second state is irreversible.

In accordance with an embodiment of the present invention, the optical signal element associated with the medical device may include a base and a first removable component, and wherein the base and the first removable component are configured to be separable. When the optical signal element is in the first state, the base and the first removable component are not separated, and when the optical signal element is in the second state, the base and the first removable component are separated.

In accordance with an embodiment of the present invention, a medical device assembly includes a medical device, an optical signal element associated with the medical device, wherein the optical signal element comprises a dye. When the optical signal element is in a first state, the optical signal element provides a first indication regarding the medical device, and when the optical signal element is in a second state, the optical signal element provides a second indication regarding the medical device based on the dye. The second state may be associated with migration of the dye to a location of the optical signal element that is observable, and wherein the second indication is different from the first indication.

In accordance with an embodiment of the present invention, the optical signal element may include a dye layer including the dye, and a non-absorbent layer associated with the dye layer. The optical signal element may be in the second state based on removal of the non-absorbent layer from contact with the dye layer.

In accordance with an embodiment of the present invention, the optical signal element may be in the first state based on the non-absorbent layer being in contact with the dye layer.

In accordance with an embodiment of the present invention, the optical signal element may include an absorbent layer, and wherein the optical signal element provides the second indication regarding the medical device based on the dye of the dye layer being absorbed by the absorbent layer.

In accordance with an embodiment of the present invention, the optical signal element provides the second indication regarding the medical device based on the dye of the dye layer being absorbed by the absorbent layer after a predetermined time interval.

In accordance with an embodiment of the present invention, the optical signal element is attached to the medical device, wherein the optical signal element is in the first state when the medical device is not attached to another device, and wherein the optical signal element transitions from the first state to the second state based on the medical device being attached to another device.

In accordance with an embodiment of the present invention, the optical signal element includes a cover layer attached to the non-absorbent layer in contact with the dye layer, and wherein the cover layer is configured to protect the dye layer and the non-absorbent layer from damage.

In accordance with an embodiment of the present invention, the optical signal element is configured to transition from the first state to the second state irreversibly.

### BRIEF DESCRIPTION OF THE DRAWINGS

Additional advantages and details are explained in greater detail below with reference to the exemplary embodiments that are illustrated in the accompanying schematic figures, in which:

FIG. 1 is a diagram of a non-limiting embodiment or aspect of an environment in which systems, devices, products, apparatus, and/or methods, described herein, may be implemented according to the principles of the present disclosure;

FIG. 2 is a diagram of a non-limiting aspect or embodiment of components of one or more devices and/or one or more systems of FIG. 1;

FIG. 3 is a flowchart of a non-limiting aspect or embodiment of a process for determining a characteristic of a medical device based on an optical signal element;

FIGS. 4A and 4B are diagrams of an implementation of a non-limiting embodiment of an optical signal element;

FIG. 5 is a diagram of an implementation of a non-limiting embodiment of an optical signal element;

FIG. 6 a diagram of a cross-section of a non-limiting embodiment of a medical device assembly including an optical signal element attached to a cap device;

FIG. 7 a diagram of a non-limiting embodiment of another medical device assembly including an optical signal element attached to a cap device; and

FIG. 8 a diagram of a non-limiting embodiment of another medical device assembly including an optical signal element attached to a cap device.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments. Hence, specific dimensions and other physical characteristics related to the embodiments disclosed herein are not to be considered as limiting.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to embodiments or aspects as they are oriented in the drawing figures. However, it is to be understood that embodiments or aspects may assume various alternative variations and step sequences, except where expressly specified to the contrary. It is also to be understood that the specific devices and processes illustrated in the attached drawings, and described in the following specification, are simply non-limiting exemplary embodiments or aspects. Hence, specific dimensions and other physical characteristics related to the embodiments or aspects of the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” As used in the specification and the claims, the singular form of “a,” “an,” and “the” include plural referents, such as unless the context clearly dictates otherwise. Additionally, Furthermore, as used herein, the terms “set” and “group” are intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. Further, the phrase “based on” is intended to mean “based at least partially on” unless explicitly stated otherwise. Further, the phrase “based on” may mean “in response to” and be indicative of a condition for automatically triggering a specified operation of an electronic device (e.g., a controller, a processor, a computing device, etc.) as appropriately referred to herein.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet and/or the like) that includes data. It will be appreciated that numerous other arrangements are possible.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Provided are improved devices, systems, methods, and products for accurately determining a characteristic of a medical device based on an optical signal element. Embodiments of the present disclosure may include a medical device management system that includes an optical signal element associated with the medical device, wherein, when the optical signal element is in a first state, the optical signal element provides a first indication regarding the medical device, and wherein, when the optical signal element is in a second state, the optical signal element provides a second indication regarding the medical device, wherein the second indication is different from the first indication. In some non-limiting embodiments, the medical device management system further comprises at least one processor programmed or configured to receive data associated with the optical signal element, determine a characteristic of the medical device based on the data associated with the optical signal element, and perform an action based on the characteristic of the medical device. In some non-limiting embodiments, when performing the action based on the characteristic of the medical device, the medical device management system is programmed or configured to provide an alert, where the alert comprises information indicating that the medical device was improperly connected to another component. In some non-limiting embodiments, when performing the action based on the characteristic of the medical device, the medical device management system is programmed or configured to is programmed or configured to provide a prompt, where the prompt comprises information indicating that a connection of the medical device to another component should be corrected to properly connect the medical device. In some non-limiting embodiments, when performing the action based on the characteristic of the medical device, the medical device management system is programmed or configured to provide a message, wherein the message comprises information indicating that the medical device was properly connected to another component. In some non-limiting embodiments, when receiving the data associated with the optical signal element attached to the medical device, the medical device management system is programmed or configured to receive the data associated with the optical signal element attached to the medical device from an optical reader device.

In some non-limiting embodiments, the optical signal element is configured to transition from the first state to the second state based on a mechanical operation carried out on the optical signal element. In some non-limiting embodiments, the optical signal element is configured to transition from the first state to the second state based on a physical property of a component of the optical signal element. In some non-limiting embodiments, the optical signal element is configured to transition from the first state to the second state based on a change in matter of a component of the optical signal element. In some non-limiting embodiments, the optical signal element associated with the medical device is attached to a connector, where the connector is configured to establish a connection with the medical device. In some non-limiting embodiments, a transition of the optical signal element from the first state to the second state is irreversible.

In this way, embodiments of the present disclosure provide an optical signal element that is able to provide accurate information with regard to the use, non-use, or reuse of a medical device. For example, an individual may be able to receive information from an optical signal element on the packaging of a medical device at the time that the packaging is removed from the medical device. In addition, a user may be able to read, with an optical reader device, an optical signal element that is positioned on the medical device that would provide information with regard to the use, non-use, or reuse of the medical device. In this way, the medical device management system and/or the optical signal element may provide an accurate and effective way of obtaining information with regard to the use, non-use, or reuse of the medical device.

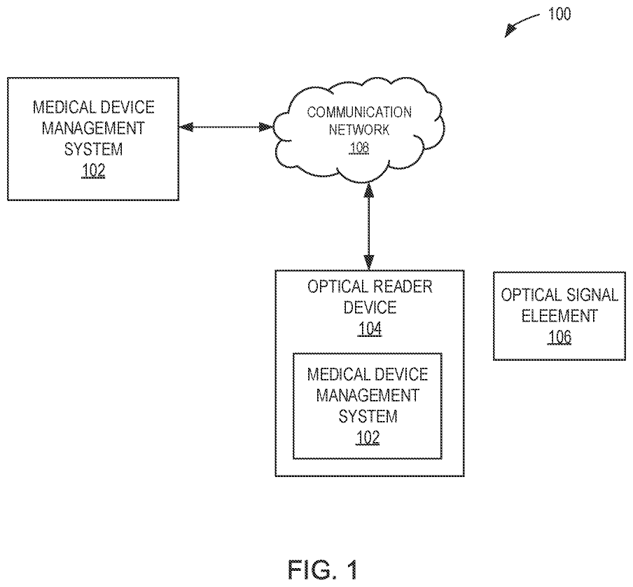

Referring now to FIG. 1, FIG. 1 is a diagram of an example environment 100 in which devices, systems, methods, and/or products described herein may be implemented. As shown in FIG. 1, environment 100 includes medical device management system 102, optical reader device 104, and optical signal element 106. Medical device management system 102 and optical reader device 104 may interconnect (e.g., establish a connection to communicate, and/or the like) via wired connections, wireless connections, or a combination of wired and wireless connections.

Medical device management system 102 may include one or more devices configured to be in communication with optical reader device 104 via communication network 108. For example, medical device management system 102 may include a server (e.g., a cloud server), a group of servers, a computing device, such as a mobile device (e.g., a smartphone) a tablet computer, a laptop computer, a desktop computer, and/or the like. In some non-limiting embodiments, medical device management system 102 may be configured to be in communication with optical reader device 104 via a direct communication connection (e.g., a communication connection that is independent of a communication network, such as communication network 108), such as a short-range wireless communication connection (e.g., a near-field communication (NFC) communication connection, a radio frequency identification (RFID) communication connection, a Bluetooth® communication connection, an infrared communication connection, etc.) or a wired communication connection (e.g., a connection that uses a cable and universal serial bus (USB) communication protocol). In some non-limiting embodiments, medical device management system 102 may be configured to determine a characteristic of a medical device based on data received from optical reader device 104. In some non-limiting embodiments, medical device management system 102 may be a component of optical reader device 104.

Optical reader device 104 may include one or more devices configured to be in communication with medical device management system 102 via communication network 108. For example, optical reader device 104 may include a server (e.g., a cloud server), a group of servers, a computing device, such as a mobile device (e.g., a smartphone, a wearable device, etc.), a tablet computer, a laptop computer, a desktop computer, and/or the like. In some non-limiting embodiments, optical reader device 104 may include one or more optical readers, one or more image capture devices (e.g., one or more cameras), one or more infrared (IR) scanners, one or more barcode readers, one or more optical sensors, and/or the like. In some non-limiting embodiments, optical reader device 104 may be configured to be in communication with medical device management system 102 via a direct communication connection (e.g., a communication connection that is independent of a communication network, such as communication network 108), such as a short-range wireless communication connection (e.g., an NFC communication connection, an RFID communication connection, a Bluetooth® communication connection, an infrared communication connection, etc.) or a wired communication connection (e.g., a connection that uses a cable and USB communication protocol).

Optical signal element 106 may include one or more devices configured to provide an optical signal, such as an indication (e.g., an optical indication, a visual indication, etc.). In some non-limiting embodiments, the optical signal may be observable. For example, the optical signal may be capable of being read (e.g., scanned, recorded, captured, such as via image capture, etc.) by an optical reader, such as optical reader device 104. Additionally or alternatively, the optical signal may be capable of being visually observed by an individual. In some non-limiting embodiments, optical signal element 106 may include a device that is configured to transition between a first state and a second state. In one example, optical signal element 106 may include a device that is configured to irreversibly transition between a first state and a second state. In another example, optical signal element 106 may include a device that is configured to reversibly transition between a first state and a second state. In some non-limiting embodiments, optical signal element 106 may include a base and a first removable component, where the base and the first removable component are configured to be separable, such that when the optical signal element is in the first state, the base and the first removable component are not separated, and when the optical signal element is in the second state, the base and the first removable component are separated. In some non-limiting embodiments, a first optical signal may be provided in the first state and a second optical signal may be provided in the second state.

In some non-limiting embodiments, when the optical signal element is in a first state, the optical signal element may provide a first optical signal (e.g., a first indication), and when the optical signal element is in a second state, the optical signal element may provide a second optical signal (e.g., a second indication) where the second optical signal is different from the first optical signal. In some non-limiting embodiments, the first optical signal and/or the second optical signal may be an indication of a characteristic of a medical device with which the optical signal element is associated. In some non-limiting embodiments, the characteristic of the medical device may include a characteristic related to use, non-use, and/or reuse of the medical device. For example, the characteristic of the medical device may include a characteristic that identifies the medical device as having been used, a characteristic that identifies the medical device as having not been used, and/or a characteristic that identifies the medical device as being able to be reused.

In some non-limiting embodiments, optical signal element 106 may transition between the first state and the second state based on a mechanical operation carried out on the optical signal element. For example, optical signal element 106 may transition between the first state and the second state based on a change induced by a mechanical element. In one example, optical signal element 106 may include a window having a material (e.g., a movable tab) that is held in a first state, such as an open position, by a cover (e.g., during manufacture, prior to use, etc.) and is configured such that once the cover is removed, the material of the window relaxes over an opening of the window so the window transitions to a second state, such as a closed position. In this way, a color that was observable in the first state may no longer be observable in the second state or vice versa. The relaxation properties of the material of the window may provide a first optical signal based on a short time interval and a second optical signal based on a longer time interval. In some non-limiting embodiments, the first optical signal and/or a second optical signal may provide an indication of a risk of contamination of a medical device. In some non-limiting embodiments, the material of the window may be configured to transition between the first state and the second state based on a connection being made (e.g., attachment) between a medical device associated with optical signal element 106 and another device (e.g., another medical device configured to connect with the medical device).

In some non-limiting embodiments, optical signal element 106 may transition between the first state and the second state based on mechanical deformation (e.g., compression, abrasion, destruction, etc.) of optical signal element 106 and/or a component of optical signal element 106 to identify re-use of a medical device. In some non-limiting embodiments, a change from the first indication to the second indication (e.g., based on a transaction from the first state to the second state) may occur due to a conformation change or an orientation change that results in a change in a magnitude of an optical signal that is observed by an individual (e.g., a user) or read by a device.

In some non-limiting embodiments, optical signal element 106 may include malleable units having an un-deformed shape (e.g., beads that are initially in a round configuration) and upon deformation, such as based on compression (e.g., based on compression of the malleable units when the malleable units are positioned within a connection between mating devices), the malleable units become flattened in a second state. In some non-limiting embodiments, the malleable units may include a material that is deformable, such as a soft polymer material (e.g., a polymer, such as TPE, a polymer blend, a copolymer blend, etc.). In some non-limiting embodiments, the material may include a wax. In some non-limiting embodiments, the malleable units may include encapsulated beads that are configured to release a liquid (e.g., a colored liquid) upon rupture of the encapsulated beads in a controlled or uncontrolled fashion. In some non-limiting embodiments, the liquid may be included in optical signal element 106 as an ink, a coating, or may be positioned in a structure of optical signal element 106, such as nano dye micelles positioned in a structure of optical signal element 106 that are configured to rupture.

In some non-limiting embodiments, optical signal element 106 may transition between the first state and the second state based on optical signal element 106 transitioning between the first state and the second state based on a physical property of optical signal element 106 or a component of optical signal element 106. For example, optical signal element 106 may transition between the first state and the second state based on a change in matter of optical signal element 106 or a component of optical signal element 106. In some non-limiting embodiments, optical signal element 106 may change one or more optical properties (e.g., change of color, increase of light scatter, decrease of light scatter, etc.) of optical signal element 106 and/or a component of optical signal element 106 based on deformation (e.g., deformation based on compression) of optical signal element 106 and/or a component of optical signal element 106. In some non-limiting embodiments, the change of one or more optical properties of optical signal element 106 may be based on one or more liquids (e.g., one or more colored liquids) that is released based on deformation of optical signal element 106 and/or a component of optical signal element 106. For example, the one or more liquids may be released from one or more chambers of optical signal element 106 based on deformation of optical signal element 106 and/or a component of optical signal element 106. In some non-limiting embodiments, the one or more liquids may be released from one or more chambers of optical signal element 106, and the one or more liquids may combine to provide the change of an optical property (e.g., a change from a first color to a second color, a change that emits light based on photoluminescence, such as phosphorescence and/or chemiluminescence, etc.) of optical signal element 106. In some non-limiting embodiments, a two-dimensional (2D) surface area (e.g., a 2D surface area that is observable) following compression may be greater than the 2D surface area of the colored material prior to compression. In some non-limiting embodiments, optical signal element 106 may rely on a color changing technology to change from one color to another, such as thermachrome, photobleaching (e.g., photobleaching of a fluorophore, a dye, or other molecule), photochromic (e.g., irreversible photochromic), piezochrome (e.g., pressure sensitive paint, pressure sensitive film, etc.), strain reactive polymers, chromatography (e.g., diffusion based ink, migrating ink, etc.), electrochromic, negative film, chemical reaction (e.g., a starch and iodine, where the iodide starts light orange-brown and then turns blue black when applied to starch), and/or the like.

In some non-limiting embodiments, optical signal element 106 may use color change technology to provide an optical signal that distinguishes between a first use and a subsequent use and/or potential accidental contact. In some non-limiting embodiments, the color change technology may be based on a migrating ink, wherein migration of the ink is initiated as a result of an initial use (e.g., connecting a medical device with which optical signal element is associated, with another device, such as a connector or a catheter hub, and disconnecting the medical device from the other device). In some non-limiting embodiments, a color change may be visible to an individual and/or may occur at wavelengths such that the color change is not visible to the individual. Additionally or alternatively, the color change may be readable by a device. In some non-limiting embodiments, the color change technology may be included on one or both devices that make up a set of mating devices. In some non-limiting embodiments, multiple color changes could occur to differentiate a medical device that has not been used, from an initial use, and subsequent uses (e.g. second use, third use), to provide an optical signal that indicates e.g., to know how many times a medical device was used (e.g., how many times tubing was connected).

In some non-limiting embodiments, optical signal element 106 may provide an optical signal based on a deformation pattern of optical signal element 106 and/or a component of optical signal element 106. In some non-limiting embodiments, the deformation pattern may be controlled based on channels included in optical signal element 106 into which a colored element associated with (e.g., included in) optical signal element 106 may move (e.g., flow) into. In some non-limiting embodiments, optical signal element 106 (e.g., malleable units of optical signal element 106) may contain a liquid that is released upon compression of optical signal element 106 and that is carried into (e.g., wicked up by) a channel or lateral flow element to provide an optical signal at a specific location (e.g., a predetermined location of a medical device to which optical signal element 106 is attached).

In some non-limiting embodiments, optical signal element 106 may transition between the first state and the second state based on the formation of a connection between a medical device and a device (e.g., another medical device) that is configured to connect (e.g., mate) with the medical device. In some non-limiting embodiments, the magnitude of an optical signal that is observable (e.g., able to be visually observable by an individual or able to be read by a device, such as an optical reader device) may differ prior to and following connection of two mating devices. In some non-limiting embodiments, an indication (e.g., an optical signal provided by optical signal element 106 that is observable) may begin as a post of color that is flattened and by way of having a small surface area due to a small cross functional area perpendicular to the surface, upon flattening or bending of the post, a larger optical signal can be observed and/or read. Optical signal element 106 may include different shapes and/or configurations as is appropriate based on the application of optical signal element 106.

In some non-limiting embodiments, optical signal element 106 may transition between the first state and the second state and may provide the optical signal following either engagement of the medical device with a mating device (e.g., another medical device that is intended to mate with the medical device) and, thereby, differentiate between the first engagement and subsequent engagement events or alternatively, upon accidental touch of the mating area of the device to indicate when the device may have been contaminated by accidental touch at a mating surface.

Communication network 108 may include one or more wired and/or wireless networks. For example, communication network 108 may include a cellular network (e.g., a long-term evolution (LTE) network, a third generation (3G) network, a fourth generation (4G) network, a fifth generation (5G), network a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of some or all of these or other types of networks.

The number and arrangement of systems and/or devices shown in FIG. 1 are provided as an example. There may be additional systems and/or devices, fewer systems and/or devices, different systems and/or devices, or differently arranged systems and/or devices than those shown in FIG. 1. Furthermore, two or more systems and/or devices shown in FIG. 1 may be implemented within a single system or a single device, or a single system or a single device shown in FIG. 1 may be implemented as multiple, distributed systems or devices. Additionally or alternatively, a set of systems or a set of devices (e.g., one or more systems, one or more devices) of environment 100 may perform one or more functions described as being performed by another set of systems or another set of devices of environment 100.

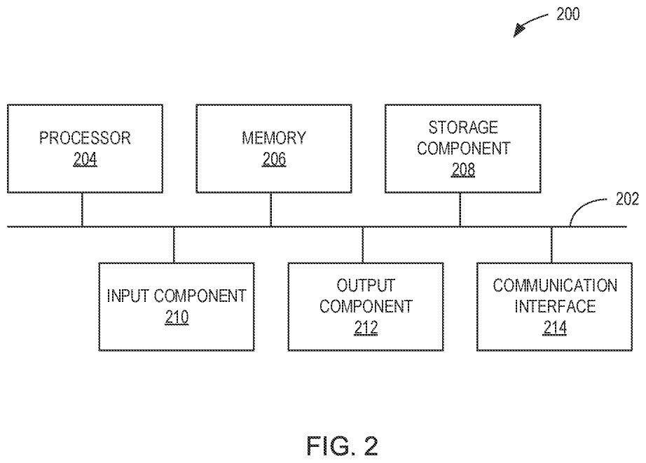

Referring now to FIG. 2, FIG. 2 is a diagram of example components of device 200. Device 200 may correspond to medical device management system 102 (one or more devices of medical device management system 102) and/or optical reader device 104. In some non-limiting embodiments, medical device management system 102 and/or optical reader device 104 may include at least one device 200 or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touchscreen display, a keyboard, a keypad, a mouse, a button, a switch, a microphone, a camera, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

Memory 206 and/or storage component 208 may include data storage or one or more data structures (e.g., a database, and/or the like). Device 200 may be capable of receiving information from, storing information in, communicating information to, or searching information stored in the data storage or one or more data structures in memory 206 and/or storage component 208. For example, the information may include data associated with a real-time mobile device application profile, data associated with a historical mobile device application profile, input data, output data, transaction data, account data, or any combination thereof.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

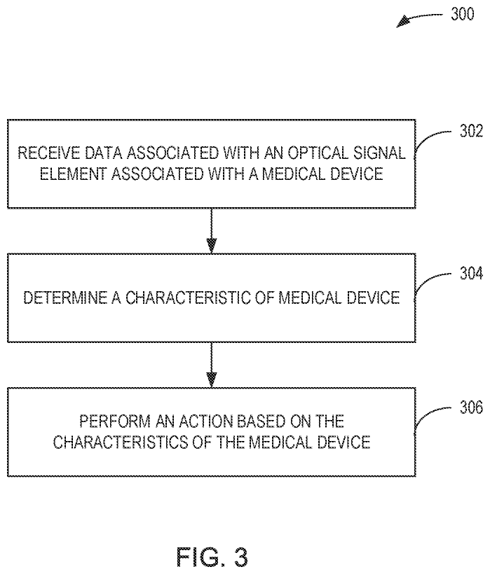

Referring now to FIG. 3, FIG. 3 is a flowchart of a non-limiting embodiment of a process 300 for determining a characteristic of a medical device. In some non-limiting embodiments, one or more of the functions described with respect to process 300 may be performed (e.g., completely, partially, etc.) by medical device management system 102. In some non-limiting embodiments, one or more of the steps of process 300 may be performed (e.g., completely, partially, and/or the like) by another device or a group of devices separate from medical device management system 102, such as optical reader device 104.

As shown in FIG. 3, at step 302, process 300 may include receiving data associated with an optical signal element associated with (e.g., attached to, positioned on, adhered to, stuck on, applied to a surface of, etc.) a medical device. For example, medical device management system 102 may receive (e.g., receive in real-time) the data associated with optical signal element 106 associated with the medical device (e.g., a container, a syringe, a catheter, a closure, such as a cap, etc.).

In some non-limiting embodiments, data associated with optical signal element 106 (e.g., first data associated with optical signal element 106, second data associated with optical signal element 106, additional data associated with optical signal element 106, etc.) may include data associated with a characteristic of the medical device.

In some non-limiting embodiments, the data associated with optical signal element 106 may include data associated with a first state (e.g., an active state, a ready to use state, an open state, a state at which a substance in the medical device is ready to be administered, an unused state, etc.) of the medical device and/or data associated with a second state (e.g., an inactive state, a not ready to use state, a closed state, a state at which a substance in the medical device is not to be administered, an already used state, etc.) of the medical device.

In some non-limiting embodiments, optical signal element 106 may provide (e.g., passively provide, visually indicate, such that a user may visually inspect) a first indication regarding the medical device when the optical signal element 106 is in a first state, and optical signal element 106 may provide a second indication regarding the medical device when the optical signal element is in a second state.

In some non-limiting embodiments, medical device management system 102 may receive the data associated with optical signal element 106 from optical reader device 104. For example, optical reader device 104 may read optical signal element 106 and obtain the data associated with optical signal element 106 based on reading optical signal element 106. Optical reader device 104 may transmit the data associated with optical signal element 106 to medical device management system 102, and medical device management system 102 may receive the data associated with optical signal element 106 from optical reader device 104 based on optical reader device 104 reading optical signal element 106.

In some non-limiting embodiments, a medical device may include a device that is used in a medical procedure. For example, the medical device may include a device that is used to establish a connection during a medical procedure, such as a luer device (e.g., a luer connector) a catheter hub, a needleless connector, a port, a manifold, a stopcock, and/or the like. In some non-limiting embodiments, the medical device may include one of a mating medical device (e.g., medical devices that are designed to be connected together) or a set of mating medical devices. For example, the medical device may include a needlefree connector and/or a corresponding cap. In another example, the medical device may include a needlefree connector and/or a syringe (e.g., a flush syringe). In another example, the medical device may include a tubing element and a syringe. In another example, the medical device may include a test cartridge and a reader (e.g., a test cartridge for an ailment, such as a disease or sickness, and a reader). In another example, the medical device may include an oral syringe and oral tubing connector. In another example, the medical device may include a syringe and needle.

As shown in FIG. 3, at step 304, process 300 may include determining a characteristic of the medical device. For example, medical device management system 102 may determine a characteristic of a medical device based on the data associated with optical signal element 106 attached to the medical device.

In some non-limiting embodiments, medical device management system 102 may determine characteristic of the medical device with which optical signal element 106 is associated. For example, medical device management system 102 may determine the characteristic of the medical device based on the data associated with optical signal element 106. In some non-limiting embodiments, medical device management system 102 may determine a characteristic of the medical device with which optical signal element 106, where the characteristic may include a state of the medical device. For example, the characteristic may include a first state (e.g., an active state, a ready to use state, an open state, a state at which a substance in the medical device is ready to be administered, an unused state, etc.) of the medical device and/or a second state (e.g., an inactive state, a not ready to use state, a closed state, a state at which a substance in the medical device is not to be administered, an already used state, etc.) of the medical device.

As shown in FIG. 3, at step 306, process 300 may include performing an action based on the characteristic of the medical device. For example, medical device management system 102 may perform an action based on the characteristic of the medical device with which optical signal element 106 is associated.

In some non-limiting embodiments, medical device management system 102 may transmit the data to a database. In some non-limiting embodiments, medical device management system 102 may transmit the data to an electronic medical record (EMR) system for automatic logging and/or safety confirmation that medication to be administered matches a medication order for an individual.

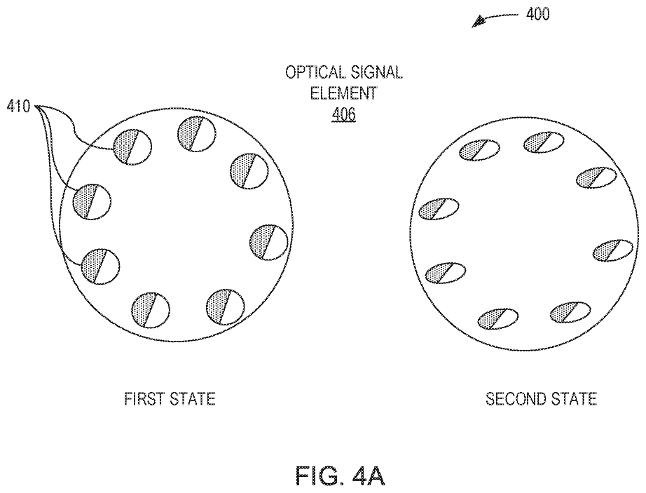

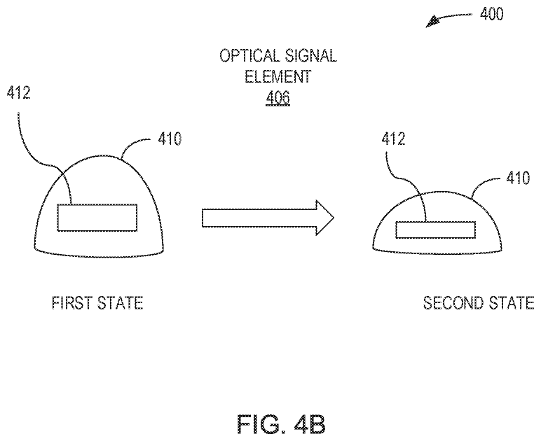

Referring to FIGS. 4A and 4B, FIGS. 4A and 4B are diagrams of non-limiting embodiments of an implementation 400 of optical signal element 406. In some non-limiting embodiments, optical signal element 406 may be the same as or similar to optical signal element 106. In some non-limiting embodiments, optical signal element 406 may be associated with a medical device. For example, optical signal element 406 may be attached to a syringe, an IV assembly, a luer connector, a catheter, tubing, a container, medication packaging, a closure (e.g., a cap), and/or the like.

As shown in FIG. 4A, optical signal element 406 may include a plurality of components 410 that are configured to change in visual appearance based on deformation of the plurality of components 410. In the example of FIG. 4A, each component 410 of the plurality of components 410 may provide a first indication when optical signal element 406 is in a first state (e.g., when all of the plurality of components 410 are in a non-deformed state), and optical signal element 406 may provide a second indication when optical signal element 406 is in a second state (e.g., when one or more of the plurality of components 410 are in a deformed state). In some non-limiting embodiments, each component 410 of the plurality of components 410 is configured to transition from the first state to the second state based on deformation of component 410. In some non-limiting embodiments, a transition of component 410 from the first state to the second state may be reversible or irreversible.

As further shown in FIG. 4A, each component 410 of the plurality of components 410 may include a shape (e.g., a circle, a hemisphere, a sphere, a bead, etc.) of color that is to be deformed (e.g., compressed, flattened, smooshed, etc.) to transition an area of color, from a first state to a second state, that is to be visible by an individual and/or read by a device (e.g., optical reader device 104). In some non-limiting embodiments, each component 410 of the plurality of components 410 may include a single color and an area of color (e.g., a window, a visible space, etc.) that is visible in the first state and may be different from an area of color that is visible in the second state. In one example, the area of color that is visible in the first state may be larger than an area of color that is visible in the second state or vice versa. In some non-limiting embodiments, each component 410 of the plurality of components 410 may include a plurality of colors, and an area of color that is visible in the first state may be different from an area of color that is visible in the second state. In one example, the area of color that is visible in the first state may be a different color than an area of color that is visible in the second state based on how the plurality of colors interact when component 410 of the plurality of components 410 is deformed to transition from the first state to the second state.

As shown in FIG. 4B, component 410 of optical signal element 406 may include area of color 412 that is configured to transition from the first state to the second state based on component 410 being deformed via a mechanical operation (e.g., a compressive force that results from two components being connected together, a compressive force that results from two components being disconnected from each other, a compressive force from a user interacting with component 410, etc.). In some non-limiting embodiments, component 410 may include an appropriate material to achieve this effect. For example, component 410 may include a foam encased in an elastic casing. As further shown in FIG. 4B, area of color 412 that is visible in the first state may be larger than area of color 412 that is visible in the second state.

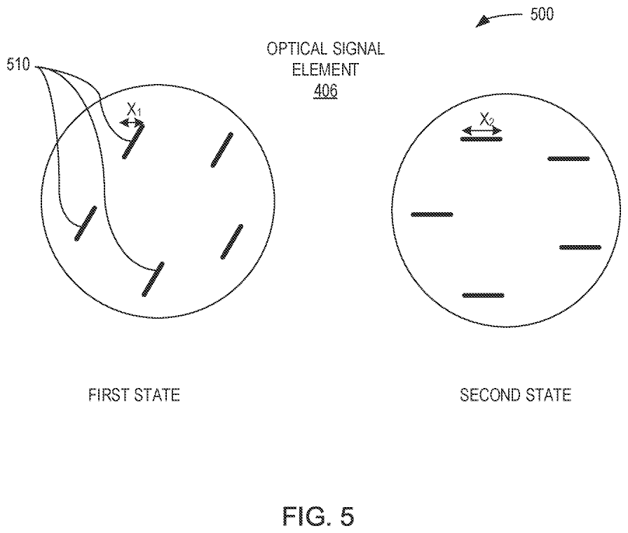

Referring to FIG. 5, FIG. 5 is a diagram of non-limiting embodiments of an implementation 500 of optical signal element 506. In some non-limiting embodiments, optical signal element 506 may be the same as or similar to optical signal element 106 and/or optical signal element 406. In some non-limiting embodiments, optical signal element 506 may be associated with a medical device. For example, optical signal element 506 may be attached to a syringe, an IV assembly, a luer connector, a catheter, tubing, a container, medication packaging, a closure (e.g., a cap), and/or the like.

As further shown in FIG. 5, optical signal element 506 may include a plurality of components 510 that are configured to change in visual appearance based on deformation of the plurality of components 510. In the example of FIG. 5, each component 510 of the plurality of components 510 may provide a first indication when optical signal element 506 is in a first state (e.g., when all of the plurality of components 510 are in a non-deformed state), and optical signal element 506 may provide a second indication when optical signal element 506 is in a second state (e.g., when one or more of the plurality of components 510 are in a deformed state). As further shown in FIG. 5, each component 510 of the plurality of components 510 may include a frangible element having a shape (e.g., a shape of a column, a shape of a pillar, a sphere, etc.) that is to be deformed (e.g., compressed, flattened, smooshed, bent, changed in orientation, etc.) to change an appearance of the frangible elements that is to be visible by an individual and/or read by a device (e.g., optical reader device 104). In some non-limiting embodiments, a surface of one or more of the frangible elements may be covered in a material that is capable of altering a path of light that hits the surface. For example, the surface may have a reflective or absorptive covering. In some non-limiting embodiments, each component 510 of the plurality of components 510 may include an area that is visible or able to be read in the first state and may be different from an area that is visible or able to be read in the second state. In one example, the area that is visible or able to be read in the first state may be larger than an area that is visible or able to be read in the second state or vice versa.

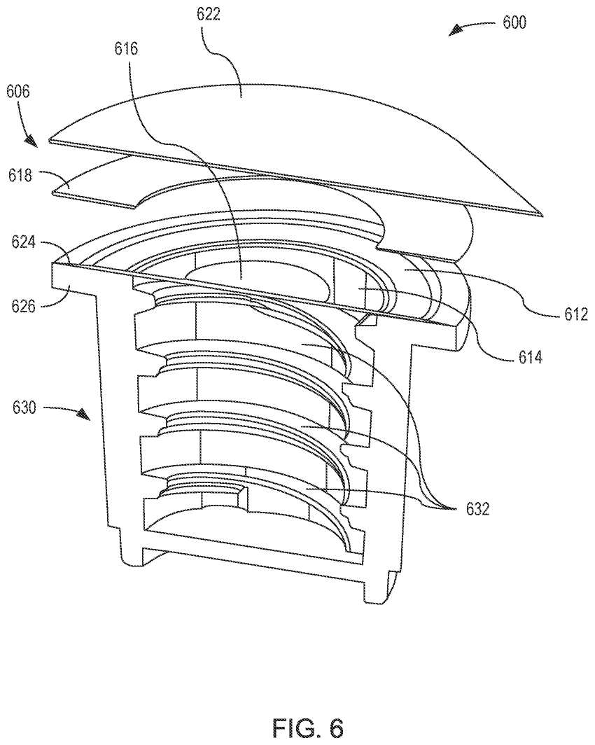

Referring to FIG. 6, FIG. 6 is a diagram of a cross-section of a non-limiting embodiment of a medical device assembly 600. As shown in FIG. 6, medical device assembly 600 may include optical signal element 606 attached to cap device 630. In some non-limiting embodiments, optical signal element 606 may be the same as or similar to optical signal element 106, optical signal element 406, and/or optical signal element 506. In some non-limiting embodiments, cap device 630 may include a cap (e.g., a mating cap) for a medical device. For example, cap device 630 may include a mating disinfecting cap for a needlefree connector. As further shown in FIG. 6, cap device 630 may include threads 632 for attaching cap device 630 to a medical device that is configured as a mating device for cap device 630.

As further shown in FIG. 6, optical signal element 606 may include a plurality of layers, one or more of which is removable from cap device 630. For example, optical signal element 606 may include dye layer 612, non-absorbent layer 614, absorbent layer 618, and cover layer 622. In some non-limiting embodiments, dye layer 612 may include a dye that is configured to be a visible to an individual and/or read by an optical reader device (e.g., optical reader device 104). In some non-limiting embodiments, the dye included in dye layer 612 may be prevented from migrating by non-absorbent layer 614. For example, non-absorbent layer 614 may prevent the dye from being absorbed by absorbent layer 618.

As further shown in FIG. 6, the plurality of layers of optical signal element 606 may be constructed in a sandwiched configuration. As further shown in FIG. 6, dye layer 612 may be positioned in annular channel 624 at outer edge surface 626 of cap device 630, where outer edge surface 626 may be a mating surface that comes into contact with a corresponding surface of a device to which cap device 630 is to be attached. Non-absorbent layer 614 may be positioned over dye layer 612 and in between dye layer 612 and absorbent layer 618. In this way, non-absorbent layer 614 may prevent the dye from dye layer 612 migrating into absorbent layer 618 when non-absorbent layer 614 is present so that optical signal element 606 does not undergo a transition from a first state to a second state before the transition is desired. Absorbent layer 618 may be positioned over non-absorbent layer 614 and in between non-absorbent layer 614 and cover layer 622. In some non-limiting embodiments, cover layer 622 may be positioned over non-absorbent layer 614 and form a final, outwardly facing layer that protects underlying layers from damage based on a surrounding environment (e.g., based on contamination from elements in a surrounding environment). According to some non-limiting embodiments, one or more layers of the plurality of layers of optical signal element 606 may be sized and configured to be attached to a medical device based on a size and configuration of the medical device.

In some non-limiting embodiments, dye layer 612 may be configured so that the dye included in dye layer 612 may migrate to (e.g., into or through, so that the dye saturates) absorbent layer 618 based on a predetermined time interval (e.g., 1 minute, 2 minutes, approximately 5 minutes, less than 5 minutes, etc.). For example, dye layer 612 may be configured so that the dye may migrate to absorbent layer 618 based on a predetermined time interval such that for a predetermined time interval following a first use of cap device 630 (e.g., connecting cap device 630 with another device, such as a needlefree connector or a catheter hub, and disconnecting cap device 630 from the other device), there may be no color change in absorbent layer 618. In some non-limiting embodiments, prior to the first use of cap device 630, optical signal element 606 may be in a first state and optical signal element 606 may provide a first indication regarding cap device 630 (e.g., an indication that cap device 630 has not been used before). In some non-limiting embodiments, upon a second use (e.g., following disconnection of cap device 630 with another device after the first use of cap device 630), a color change is visibly observable and/or readable (e.g., readable by optical reader device 104). In some non-limiting embodiments, following expiration of the predetermined time interval and after the first use of cap device 630, optical signal element 606 may be in a second state and optical signal element 606 may provide a second indication regarding cap device 630 (e.g., an indication that cap device 630 has been used before). In some non-limiting embodiments, a color change absorbent layer 618 happens gradually based on the dye. In some non-limiting embodiments, the color change may be at a high intensity (e.g., a magnitude of observability that is in regards to a measurement of observability) following expiration of the predetermined time interval. After the desired time has been reached, the color will remain at its darkest. In some non-limiting embodiments, upon reading optical signal element 606, medical device management system 102 may store data (e.g., in a data structure, such as a database associated with medical device management system 102) indicating that cap device 630 has been used before.

In some non-limiting embodiments, non-absorbent layer 614 and cover layer 622 may be attached to each other (e.g., via adhesive, via a heat seal, etc.). In this way, with removal of cover layer 622 (e.g., via a peeling action of cover layer 622 from cap device 630), non-absorbent layer 614 will also be removed. Upon removal of cover layer 622 and non-absorbent layer 614, cap device 630 may be threaded onto another device, placing absorbent layer 618 and dye layer 612 in contact with each other.

In some non-limiting embodiments, non-absorbent layer 614 may include (e.g., be constructed from) a material (e.g., a non-porous material) that prevents the dye from migrating into non-absorbent layer 614. In some non-limiting embodiments, non-absorbent layer 614 may include a material that is transparent. In some non-limiting embodiments, non-absorbent layer 614 may include indicator 616 on an outer surface of non-absorbent layer 614. In some non-limiting embodiments, indicator 616 may provide an indication (e.g., an observable indication) that non-absorbent layer 614 is positioned in place (e.g., where non-absorbent layer 614 is constructed from a transparent material). In some non-limiting embodiments, absorbent layer 618 may include a material (e.g., paper) that is configured to absorb the dye from dye layer 612. For example, absorbent layer 618 may include a material that is configured to absorb the dye when absorbent layer 618 is in contact with dye layer 612. In some non-limiting embodiments, cover layer 622 may include a material (e.g., metal) that is configured to protect underlying layers from damage based on a surrounding environment.

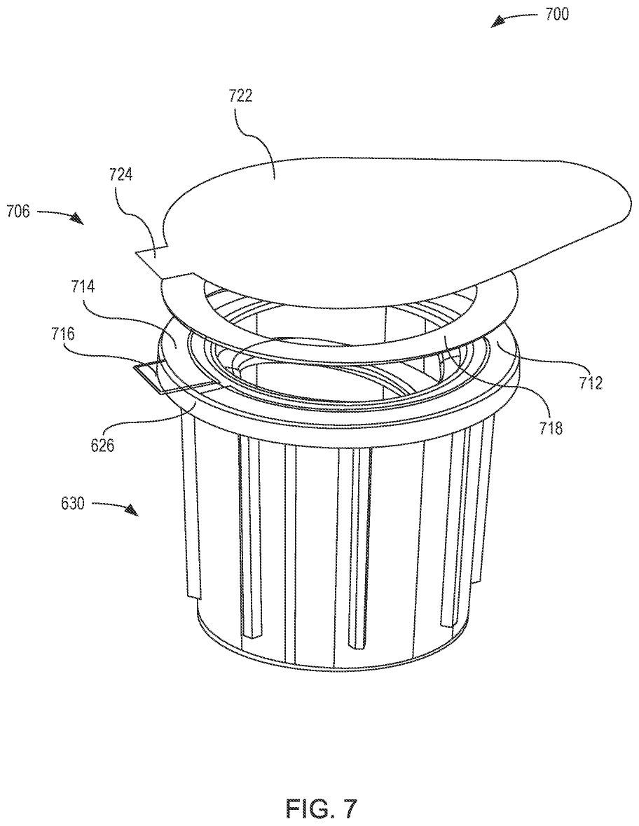

Referring to FIG. 7, FIG. 7 is a diagram of a non-limiting embodiment of a medical device assembly 700. As shown in FIG. 7, medical device assembly 700 may include optical signal element 706 attached to cap device 630. In some non-limiting embodiments, optical signal element 706 may be the same as or similar to optical signal element 106, optical signal element 406, optical signal element 506, and/or optical signal element 606.

As further shown in FIG. 7, optical signal element 706 may include a plurality of layers, one or more of which is removable from cap device 630. For example, optical signal element 706 may include dye layer 712, non-absorbent layer 714, absorbent layer 718, and cover layer 722. In some non-limiting embodiments, dye layer 712 may be the same as or similar to dye layer 612. In some non-limiting embodiments, dye layer 712 may be positioned on outer edge surface 626 of cap device 630. Non-absorbent layer 714 may be positioned over dye layer 712 and in between dye layer 712 and absorbent layer 718. In this way, non-absorbent layer 714 may prevent the dye from dye layer 712 migrating into absorbent layer 718 when non-absorbent layer 714 is present so that optical signal element 706 does not undergo a transition from a first state to a second state before the transition is desired.

Absorbent layer 718 may be positioned over non-absorbent layer 714 and in between non-absorbent layer 714 and cover layer 722. In some non-limiting embodiments, cover layer 722 may be positioned over non-absorbent layer 714 and form a final, outwardly facing layer that protects underlying layers from damage based on a surrounding environment (e.g., based on contamination from elements in a surrounding environment). According to some non-limiting embodiments, one or more layers of the plurality of layers of optical signal element 706 may be sized and configured to be attached to a medical device based on a size and configuration of the medical device. For example, non-absorbent layer 714 and/or absorbent layer 718 may be sized and configured to have an annular ring shape that corresponds to outer edge surface 626 of cap device 630.

In some non-limiting embodiments, removal of non-absorbent layer 714 may not be accomplished with removal of dust cover 722. As further shown in FIG. 7, non-absorbent layer 714 may be attached to dust cover 722 via tab 716 of non-absorbent layer 714 and tab 724 of cover layer 722, where tab 716 and tab 721 are attached to each other. In this way, when cover layer 722 is fully removed, cover layer 722 may still be attached to non-absorbent layer 714 and by pulling in a centripetal motion, an individual may completely remove non-absorbent layer 714, which exposes dye layer 712. In this way, the design of optical signal element 706 provides the benefit of keeping an opening of cap device 630 free of obstruction, other than cover layer 722.

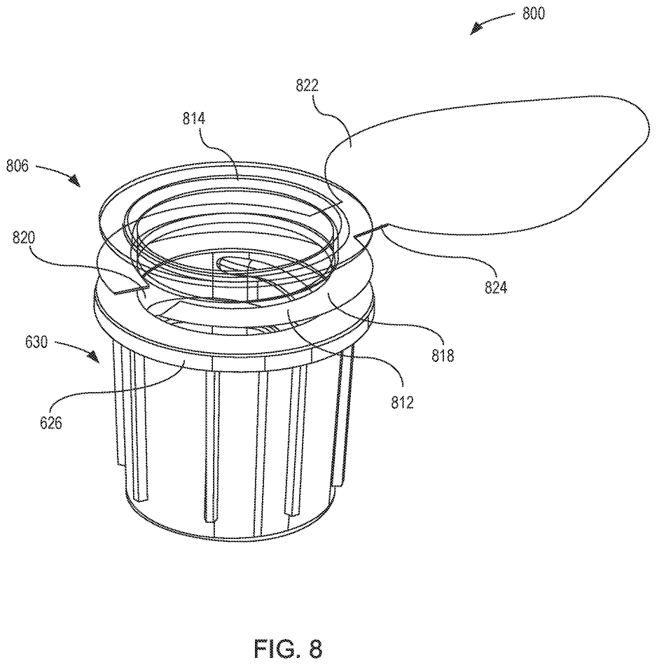

Referring to FIG. 8, FIG. 8 is a diagram of a non-limiting embodiment of a medical device assembly 800. As shown in FIG. 8, medical device assembly 800 may include optical signal element 806 attached to cap device 630. In some non-limiting embodiments, optical signal element 806 may be the same as or similar to optical signal element 106, optical signal element 406, optical signal element 506, optical signal element 606, and/or optical signal element 706.

As further shown in FIG. 8, optical signal element 806 may include a plurality of layers, one or more of which is removable from cap device 630. For example, optical signal element 806 may include dye layer 812, non-absorbent layer 814, absorbent layer 818, and cover layer 822. In some non-limiting embodiments, dye layer 812 may be the same as or similar to dye layer 612 and/or dye layer 712. In some non-limiting embodiments, dye layer 812 may be positioned on outer edge surface 626 of cap device 630. In some non-limiting embodiments, non-absorbent layer 814 may be positioned over dye layer 812 and in between dye layer 812 and absorbent layer 818 (e.g., this configuration not shown in FIG. 8). In this way, non-absorbent layer 814 may prevent the dye from dye layer 812 migrating into absorbent layer 818 when non-absorbent layer 814 is present so that optical signal element 806 does not undergo a transition from a first state to a second state before the transition is desired. In some non-limiting embodiments, non-absorbent layer 814 may be constructed as a removale closure (e.g., cap).

Absorbent layer 818 may be positioned over non-absorbent layer 814 and in between non-absorbent layer 814 and cover layer 822. In some non-limiting embodiments, cover layer 822 may be positioned over non-absorbent layer 814 and form a final, outwardly facing layer that protects underlying layers from damage based on a surrounding environment (e.g., based on contamination from elements in a surrounding environment). According to some non-limiting embodiments, one or more layers of the plurality of layers of optical signal element 806 may be sized and configured to be attached to a medical device based on a size and configuration of the medical device. For example, non-absorbent layer 814 and/or absorbent layer 818 may be sized and configured to have a broken annular ring shape (e.g., a C-shape) that corresponds to outer edge surface 626 of cap device 630. As further shown in FIG. 8, absorbent layer 818 may include gap 820, and absorbent layer 818 may be attached to cover layer 822 via tab 824. In some non-limiting embodiments, non-absorbent layer 814 may replace absorbent layer 818 as shown in FIG. 8. For example, non-absorbent layer 814 may include a gap which may be attached to cover layer 822 via a tab. In this way, with optical signal element 806, removal of absorbent layer 818 or non-absorbent layer 814 may be accomplished with removal of dust cover 822.

Although non-limiting embodiments have been described in detail for the purpose of illustration and description, it is to be understood that such detail is solely for that purpose and that embodiments are not limited to the disclosed embodiments, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, many of these features can be combined in ways not specifically recited in the claims and/or disclosed in the specification. Although each dependent claim listed below may directly depend on only one claim, the disclosure of possible implementations includes each dependent claim in combination with every other claim in the claim set.

1. An optical signal element for a single-use medical device, comprising:
an optical signal element associated with a medical device;
wherein, when the optical signal element is in a first state, the optical signal element provides a first indication regarding the medical device; and
wherein, when the optical signal element is in a second state, the optical signal element provides a second indication regarding the medical device, wherein the second indication is different from the first indication;
wherein the optical signal element is configured to transition from the first state to the second state based on a mechanical operation carried out on the optical signal element; and
at least one processor programmed or configured to:
receive data associated with the optical signal element;
determine a characteristic of the medical device based on the data associated with the optical signal element; and
perform an action based on the characteristic of the medical device.

2. The system of claim 1, wherein the optical signal element comprises:
a window having a material; and
a cover; and
wherein, when the optical signal element is in the first state, the window is held in an open position by the cover; and
wherein, when the optical signal element is in the second state, the material of the window covers an opening of the window so that the window is in a closed position; and
wherein the optical signal element transitions from the first state to the second state based on the cover being removed and the material of the window relaxing over the opening of the window.

3. The system of claim 2, wherein, when performing the action based on the characteristic of the medical device, the at least one processor is programmed or configured to:
provide an alert, wherein the alert comprises information indicating that the medical device was improperly connected to another component.

4. The system of claim 2, wherein, when performing the action based on the characteristic of the medical device, the at least one processor is programmed or configured to:
provide a prompt, wherein the prompt comprises information indicating that a connection of the medical device to another component should be corrected to properly connect the medical device.

5. The system of claim 2, wherein, when performing the action based on the characteristic of the medical device, the at least one processor is programmed or configured to:
provide a message, wherein the message comprises information indicating that the medical device was properly connected to another component.

6. The system of claim 2, wherein, when receiving the data associated with the optical signal element attached to the medical device, the at least one processor is programmed or configured to:
receive the data associated with the optical signal element attached to the medical device from an optical reader device.

7. The system of claim 1, wherein the optical signal element transitions from the first state to the second state based on mechanical deformation of the optical signal element.

8. The system of claim 1, wherein the optical signal element is configured to transition from the first state to the second state based on a physical property of a component of the optical signal element.

9. The system of claim 1, wherein the optical signal element is configured to transition from the first state to the second state based on a change in matter of a component of the optical signal element.

10. The system of claim 1, wherein the optical signal element associated with the medical device is attached to a connector associated with the medical device, and wherein the connector is configured to establish a connection with the medical device.

11. The system of claim 1, wherein a transition of the optical signal element from the first state to the second state is irreversible.

12. The system of claim 1, wherein the optical signal element associated with the medical device comprises a base and a first removable component, and wherein the base and the first removable component are configured to be separable;
wherein, when the optical signal element is in the first state, the base and the first removable component are not separated; and
wherein, when the optical signal element is in the second state, the base and the first removable component are separated.

13. A medical device assembly comprising:
a medical device;
an optical signal element associated with the medical device, wherein the optical signal element comprises a dye;
wherein, when the optical signal element is in a first state, the optical signal element provides a first indication regarding the medical device; and
wherein, when the optical signal element is in a second state, the optical signal element provides a second indication regarding the medical device based on the dye, wherein the second state is associated with migration of the dye to a location of the optical signal element that is observable, and wherein the second indication is different from the first indication.

14. The medical device assembly of claim 13, wherein the optical signal element comprises:
a dye layer including the dye, and
a non-absorbent layer associated with the dye layer; and
wherein the optical signal element is in the second state based on removal of the non-absorbent layer from contact with the dye layer.

15. The medical device assembly of claim 14, wherein the optical signal element is in the first state based on the non-absorbent layer being in contact with the dye layer.

16. The medical device assembly of claim 14, wherein the optical signal element comprises an absorbent layer, and wherein the optical signal element provides the second indication regarding the medical device based on the dye of the dye layer being absorbed by the absorbent layer.

17. The medical device assembly of claim 16, wherein the optical signal element provides the second indication regarding the medical device based on the dye of the dye layer being absorbed by the absorbent layer after a predetermined time interval.

18. The medical device assembly of claim 17, wherein the optical signal element is attached to the medical device, wherein the optical signal element is in the first state when the medical device is not attached to another device, and wherein the optical signal element transitions from the first state to the second state based on the medical device being attached to another device.

19. The medical device assembly of claim 14, wherein the optical signal element comprises:
a cover layer attached to the non-absorbent layer in contact with the dye layer, and wherein the cover layer is configured to protect the dye layer and the non-absorbent layer from damage.

20. The medical device assembly of claim 13, wherein the optical signal element is configured to transition from the first state to the second state irreversibly.
